(19) United States
(12) Patent Application Publication
(10) Pub. No.: US 2014/0079360 A1
(43) Pub. Date: Mar. 20, 2014

(54) NANOTUBE FIBER OPTIC CABLE

(71) Applicant: Tyson York WINARSKI, Mountain View, CA (US)

(72) Inventor: Tyson York WINARSKI, Mountain View, CA (US)

(21) Appl. No.: 13/869,940

(22) Filed: Apr. 24, 2013

Related U.S. Application Data
(60) Provisional application No. 61/701,722, filed on Sep. 17, 2012.

(51) Int. Cl. G02B 6/02

(52) U.S. Cl. CPC G02B 6/0229; B82Y 20/00
USPC 385/102; 977/742; 977/743

(57) ABSTRACT

A fiber optic cable is disclosed that includes an optic fiber contained within a nanotube. A graphene layer covers an end-surface of the optic fiber for wear protection.

This application claims the benefit of U.S. Provisional Application No. 61/701,722, filed Sep. 17, 2012.

### BACKGROUND

Fiber optic cables are favored for modern data communication. Fiber optic cable offers large bandwidth for high-speed data transmission. Signals can be sent farther than across copper cables without the need to “refresh” or strengthen the signal. Fiber optic cables offer superior resistance to electromagnetic noise, such as from adjoining cables. In addition, fiber optic cables require far less maintenance than metal cables, thereby making fiber optic cables more cost effective.

Optical fiber is made of a core that is surrounded by a cladding layer. The core is the physical medium that transports optical data signals from an attached light source to a receiving device. The core is a single continuous strand of glass or plastic that is measured (in microns) by the size of its outer diameter. The larger the core, the more light the cable can carry. All fiber optic cable is sized according to its core diameter. The three diameters of the most commonly available multimode cores are 50-micron, 62.5-micron, and 100-micron, although single-mode cores may be as small as 8-10 microns in diameter. The cladding is a thin layer that surrounds the fiber core and it is the core-cladding boundary that contains the light waves within the core by causing the high-angle reflection (as measured relative to a line perpendicular to this boundary, such as a core-diametral line, enabling data to travel throughout the length of the fiber segment. Typically, the core and cladding are made of high-purity silica glass. The light signals remain within the optical fiber core due to total or near-total internal reflection within the core, which is caused by the difference in the refractive index between the cladding and the core.

The cladding is typically coated with a layer of acrylate polymer or polymide, thereby forming an insulating jacket. This insulating jacket protects the optic fiber from damage. This coating also reinforces the optic fiber core, absorbs mechanical shocks, and provides extra protection against excessive cable bends. These insulating jacket coatings are measured in microns and typically range from 250 microns to 900 microns.

Strengthening fibers are then commonly wrapped around the insulating jacket. These fibers help protect the core from crushing forces and excessive tension during installation. The strengthening fibers can be made of KEVLAR™ for example.

An outer cable jacket is then provided as the outer layer of the cable. The outer cable jacket surrounds the strengthening fibers, the insulating jacket, the cladding and the optic fiber core. Typically, the outer cable jacket is colored orange, black, or yellow.

A fiber optic communications network includes a multitude of fiber optic connections. At these connections, the ends of two different fiber optic cables are coupled together to facilitate the transmission of light between them. At these ends of the fiber optic cables, the optic fiber core and cladding is exposed to the environment. When the ends of the optic fiber core and cladding are free of damage, dirt, or debris, light is transmitted clearly between the two fiber optic cables. However, if either of the fiber optic cable ends has damage to the optic fiber core or cladding, the damage can prevent the transmission of light, causing back reflection, insertion loss, and damage to other network components. Typically, most fiber optic connectors are not inspected for damage until after a transmission problem is detected, which is often after permanent damage has been caused to other fiber optic equipment.

It is therefore desirable to develop technologies that can prevent damage to the ends of fiber optic cable to ensure the clear transmission of light signals at connections between different fiber optic cables.

### SUMMARY

A fiber optic cable is disclosed that includes an optic fiber. A graphene layer covers an end-surface of the optic fiber for wear protection. Grahpene is a hard material that is 97.7% optically transparent. Graphene is a flat monolayer of carbon atoms that are tightly packed into a two-dimensional lattice, thereby forming a sheet of graphene. Graphene is 97.7% optically transparent. Thus, light can pass through a graphene layer for purposes of data transmission within an optic fiber communications network. Graphene is an extremely strong material due to the covalent carbon-carbon bonds. It is desirable to utilize graphene lattices that are defect free as the presence of defects reduces the strength of graphene lattice. The intrinsic strength of a defect free sheet of graphene 100 is 42 Nm⁻¹, making it one of the strongest materials known. The strength of graphene is comparable to the hardness of diamonds. As such, graphene is an effective material for wear protection. In one configuration, the graphene layer is attached to the fiber optic core. In another configuration, the graphene layer is embedded in the cladding and the optic fiber. The graphene layer is formed of a contiguous sheet of graphene. The graphene layer may also have a uniform thickness. In one configuration, the contiguous sheet of graphene is a monolayer of carbon atoms. The graphene layer is attached to the fiber optic cable such that a longitudinal axis of the optic fiber core is perpendicularly oriented to a plane formed by the contiguous sheet of graphene.

The optic fiber may be surrounded by cladding. The fiber optic cable may further include an insulating jacket that surrounds the cladding. In one embodiment, the graphene layer is bonded to the fiber optic core. In another embodiment, the graphene layer is bonded to the fiber optic core and the cladding.

A fiber optic cable is disclosed that includes a sheet of graphene covering an end of an optic fiber. In this embodiment, the sheet of graphene is directly attached to said optic fiber. In addition, the sheet of graphene is formed of a contiguous lattice of carbon atoms. Further, a longitudinal axis of the optic fiber is oriented perpendicularly to a plane of the sheet of graphene. In addition, the sheet of graphene has a uniform thickness.

A fiber optic cable is disclosed that includes an optic fiber coated with graphene. The graphene is formed of a plane of carbon atoms oriented perpendicularly to a longitudinal axis of the optic fiber. The cable of this embodiment may also include a cladding that surrounds the optic fiber. Further, the fiber optic cable of this embodiment may also include an insulating jacket that surrounds the cladding.

The graphene sheet covering or coating the end of the optic fiber is provided as a wear protection layer for the optic fiber. The fiber optic cable may also include a nanotube that contains the optic fiber. This nanotube may be a carbon nanotube. This nanotube may also be an inorganic nanotube. One example of an inorganic nanotube is a metal oxide. Another example of an inorganic nanotube is one formed of a transition metal-chalcogen-halogenide material. In a fiber optic cable that includes a nanotube, the fiber optic cable may also include cladding that surrounds the optic fiber and is contained within the nanotube. Alternatively, the cladding may surround the nanotube, with the optic fiber contained within the nanotube. When used in conjunction with a nanotube, the optic fiber is a nanofiber. When used with a nanotube, the graphene layer is attached to the nanotube. The graphene layer may be attached to a carbon nanotube by carbon-carbon bonds formed between the graphene layer and the carbon nanotube. Alternatively, a fiber optic cable may be formed of a nano-optic fiber contained within a nanotube.

Further aspects of the invention will become apparent as the following description proceeds and the features of novelty which characterize this invention are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of the preferred embodiment of the present invention when read in conjunction with the accompanying drawings, wherein:

FIG. 1 illustrates an isometric view of a conventional fiber optic cable;

FIG. 2 illustrates an end view of an undamaged conventional optic fiber surrounded by cladding;

FIG. 3 illustrates the transmission of light between two joined conventional fiber optic cables that have undamaged surfaces;

FIG. 4 illustrates an end view of a damaged conventional optic fiber;

FIG. 5 illustrates the transmission of light between two joined conventional fiber optic cables that have damaged surfaces;

FIG. 6 illustrates a graphene sheet;

FIG. 7 illustrates an isometric view of a fiber optic cable connector having a graphene sheet covering an end of the fiber optic cable;

FIG. 8 illustrates a sectional view of an end of a fiber optic cable having a graphene sheet covering an optic fiber;

FIG. 9 illustrates a flow chart depicting a process for securing a graphene sheet to a fiber optic cable for wear protection;

FIG. 10 illustrates a flow diagram depicting an exemplary process for securing a graphene sheet to a fiber optic cable for wear protection;

FIG. 11 illustrates an isometric view of a fiber optic cable in which an optic fiber and cladding are contained within a nanotube;

FIG. 12 illustrates an isometric view of an optic fiber surrounded by cladding and contained within a nanotube having an end covered with a graphene layer;

FIG. 13 illustrates a flow chart depicting an exemplary process for securing a graphene sheet to a fiber optic cable that is formed of an optic fiber surrounded by cladding contained within a carbon nanotube;

FIG. 14 illustrates an isometric view of an alternative fiber optic cable in which an optic fiber is contained within a nanotube with cladding surrounding the nanotube;

FIG. 15 illustrates an isometric view of an optic fiber contained within a carbon nanotube having an end covered with a graphene layer; and

FIG. 16 illustrates a flow chart depicting an exemplary process for securing a graphene sheet to a fiber optic cable that is formed of an optic fiber contained within a carbon nanotube.

### DETAILED DESCRIPTION

While the invention has been shown and described with reference to a particular embodiment thereof, it will be understood to those skilled in the art, that various changes in form and details may be made therein without departing from the spirit and scope of the invention.

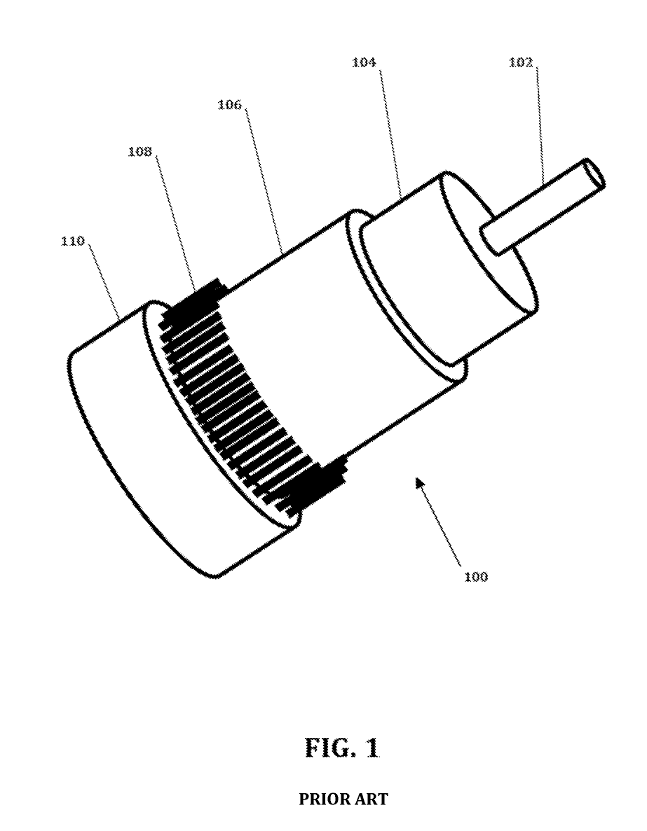

FIG. 1 illustrates an isometric view of a conventional fiber optic cable 100. Fiber optic cable 100 includes an optical fiber core 102, herein referred to as an optic fiber. Cable 100 also includes cladding 104 that concentrically surrounds optical fiber 102. An insulating jacket 106 concentrically surrounds cladding 104. Strengthening fibers 108 are provided to add mechanical strength to cable 100. A jacket cover 110 is then provided to enclose strengthening fibers 108 within cable 100.

Optic fiber 102 is the physical medium that transports optical data signals from an attached light source at one end of cable 100, such as a SFP, small form-factor pluggable, (not shown) to a receiving device on the other end, which is typically another SFP (not shown). Optic fiber 102 is a single continuous strand of glass or plastic that is measured (in microns) by the size of its outer diameter. Cladding 104 is a thin layer that surrounds the optic fiber 102 and the core-cladding boundary contains the light waves within the optic fiber by causing the high-angle light-containing reflection, enabling data to travel throughout the length of optic fiber 102. Typically, optic fiber 102 and cladding 104 are made of high-purity silica glass. The light signals remain within optical fiber 102 due to total or near-total internal reflection at the core-cladding boundary, which is caused by the difference in the refractive index between cladding 104 and optic fiber 102.

Cladding 104 is typically coated with a layer of acrylate polymer or polymide, thereby forming an insulating jacket 106. Insulating jacket 106 protects optic fiber 102 from damage. Coating 106 also reinforces optic fiber 102, absorbs mechanical shocks, and provides extra protection against excessive cable bends.

Strengthening fibers 108 are provided to add mechanical strength to cable 100. Typically, strengthening fibers are made of KEVLAR™, which is a para-aramid synthetic fiber and has the chemical name of poly-paraphenylene terephthalamide. A similar fiber called Twaron or nanotubes could be used as strengthening fibers 108. An outer jacket 110 is then provided to enclose cable 100 and protect optic fiber 102, cladding 104, insulating jacket 106, and strengthening fibers 108.

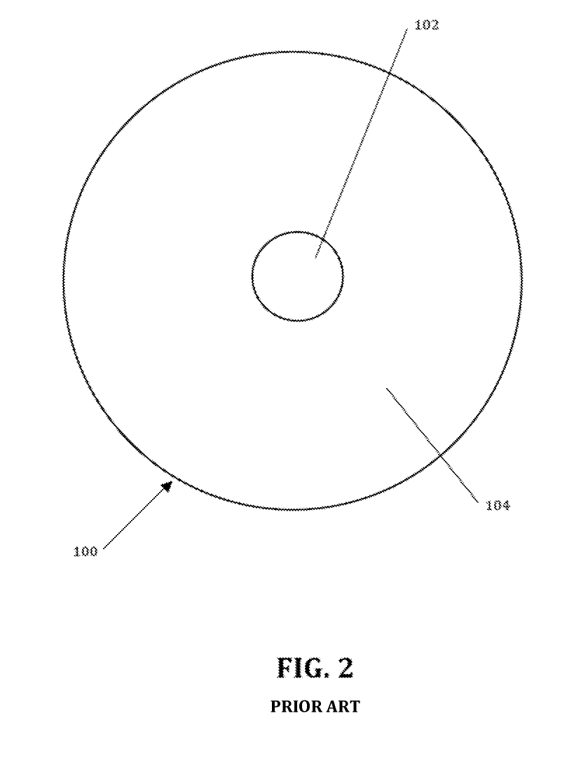

FIG. 2 illustrates an end view of an undamaged conventional optic fiber 102 surrounded by cladding 104 of a fiber optic cable 100. This figure illustrates a “clean” end of a fiber optic cable that is not damaged. As such, cable 100 is capable of transmitting a clear signal to an adjoining cable that is similarly clean and not damaged.

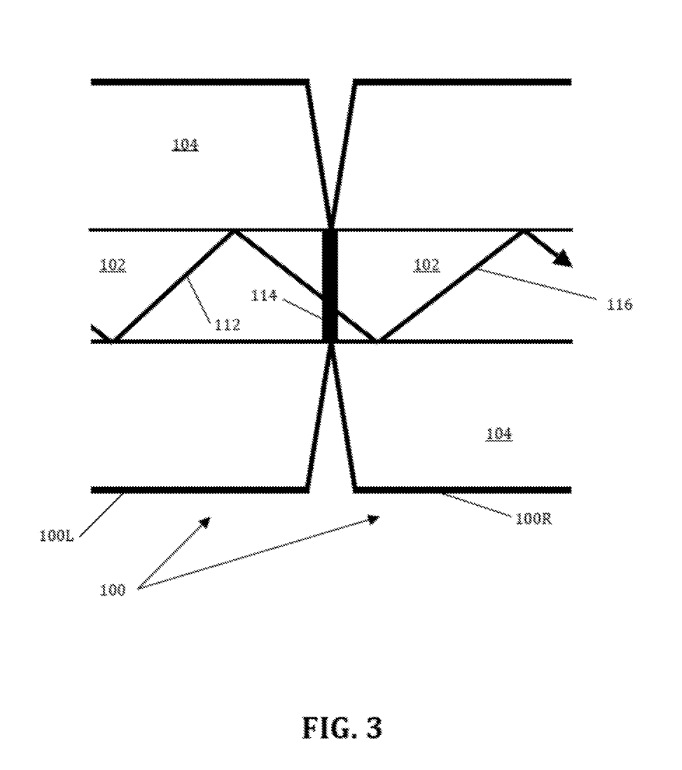

FIG. 3 illustrates the transmission of light between two joined conventional fiber optic cables 100 that have undamaged end-surfaces 114. Fiber optic cables 100 include optic fiber core 102 and cladding 104. An optical signal 112 propagates through core 102 from the cable 100 on the left 100L across core end-surfaces 114 into the cable 100 on the right 100R where it is shown as optical signal 116. When the core end-surfaces 114 of the two optical cables 100 are clean and free of damage, optical signal 112 is transmitted clearly and without distortion or loss of signal amplitude or such that optical signal 116 has the same strength of signal as optical signal 112.

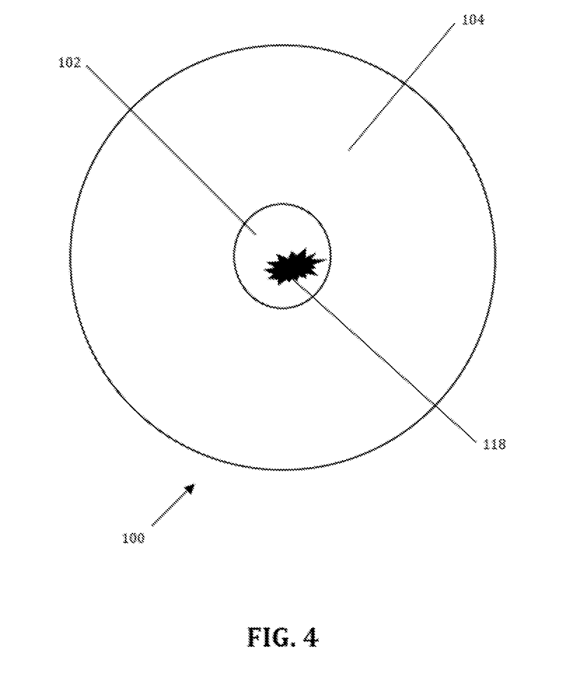

FIG. 4 illustrates an end view of a damaged conventional optic fiber cable 100. In this figure, fiber optic cable 100, which includes core 102 and cladding 104, has damage 118 to the end-surface of core 102. Damage 118 is surface damage to the end of core 102 such as a scratch, dent, chip, or other surface damage. Damage 118 negatively impacts the transmission of light signals by cable 100. Damage 118 and prevent the propagation of light signals from the source of the signal to the receiver. In addition, damage 118 can cause the light signals to reflect and bounce back to the source of the signal.

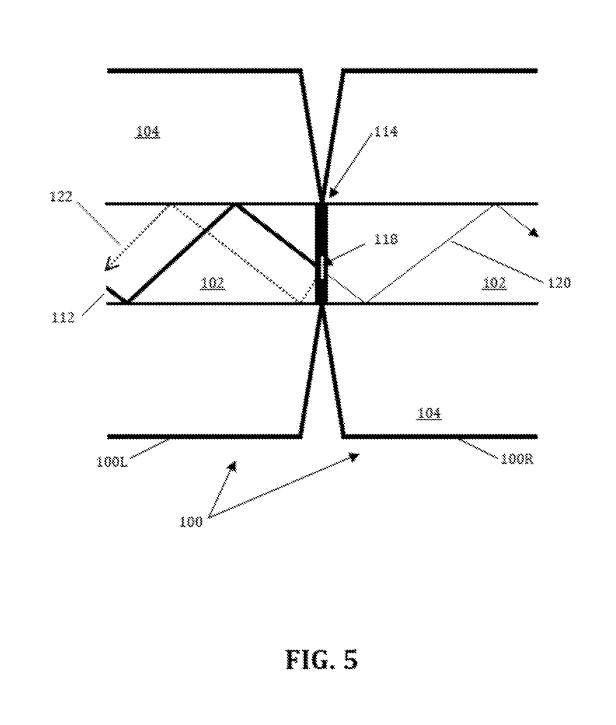

FIG. 5 illustrates the transmission of light between two joined conventional fiber optic cables 100 that have damage 118 to one or both core end-surfaces 114. Conventional fiber optic cables 100 include cores 102 and cladding 104. A light signal 112 is transmitted through cable 100 on the left 100L. Light signal 112 reaches the core end-surface 114 where it interacts with damage 118. Damage 118 can degrade the strength of signal 112, causing a weakened signal 120, a signal of lower amplitude than signal 116 of FIG. 3, to continue to propagate in cable 100 on the right 100R. Damage 118 can also cause some or all of signal 112 to be reflected back to the signal source as signal 122. As such, it is highly desirable to provide protection to the end-surfaces 114 of cores 102 of cables 100 to prevent signal-reducing damage to the core end-surfaces 114 of cables 100 in order to prevent unwanted reflective signals 122 and signals of reduced strength 120 as signal 112 crosses the junction between cores 102 of cables 100.

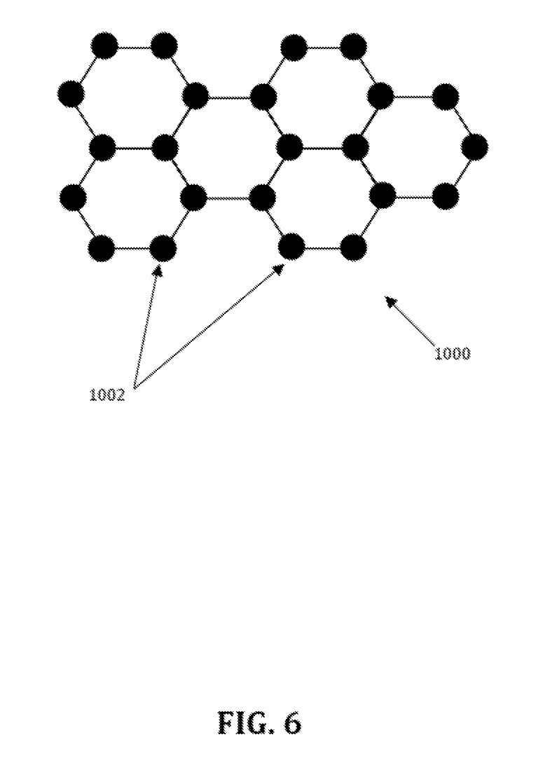

FIG. 6 illustrates a graphene sheet 1000. Graphene sheet 1000, also referred to as a graphene lattice 1000, is a flat monolayer of carbon atoms 1002 that are tightly packed into a two-dimensional lattice, thereby forming a sheet of graphene. Graphene lattice 1000 is 97.7% optically transparent. Thus, light used in combination with fiber optic cables can pass through a graphene layer for purposes of data transmission within a fiber optic communications network. Graphene lattice 1000 is an extremely strong material due to the covalent carbon-carbon bonds. It is desirable to utilize graphene lattices 1000 that are defect free as the presence of defects reduces the strength of graphene lattice 1000. The intrinsic strength of a defect free sheet of graphene 100 is 42 Nm⁻¹, making it one of the strongest materials known. The strength of graphene is comparable to the hardness of diamonds.

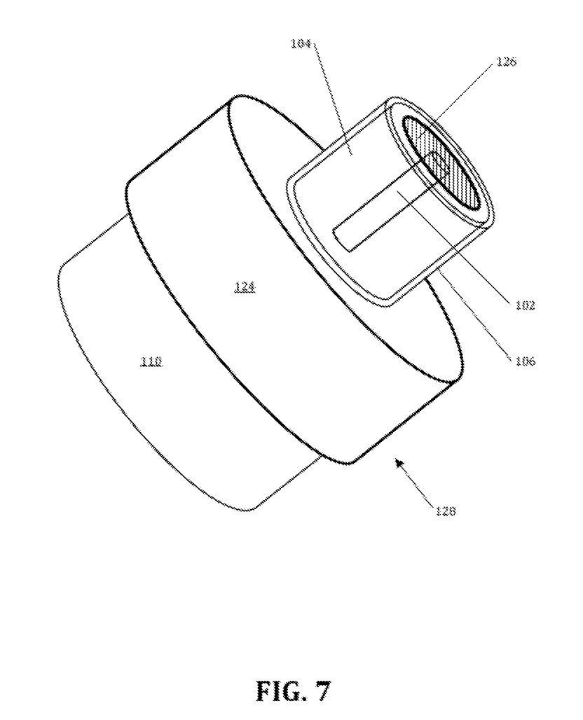

FIG. 7 illustrates an isometric view of a fiber optic cable connector 124 having a graphene sheet 126 covering an end of the fiber optic cable 128. A mechanical connector 124 is secured to the end of cable 128 in order to secure it to another fiber optic connector to connect it to a fiber optical communications network or a SFP device. Outer jacket 110 of cable 128 is shown leading into connector 124. While shown as a cylinder, connector 124 is typically a plastic or metal component configured to mate with another connector component to form a mechanical connection to hold cable 128 in position to allow for the transmission of light signals from core 102 into an adjoining core of another fiber optic cable. Core 102, cladding 104, and insulating jacket 106 are shown extending from connector 124 in order to form a fiber optic connection with an adjoining fiber optic cable.

In order to protect core 102 and cladding 104 from damage from abrasion or other mechanical damage, graphene layer 126 is attached to the end of cable 128. Graphene layer 126 is a contiguous sheet of graphene in that it is made of a single contiguous lattice of carbon atoms. Graphene layer 126 has a uniform thickness, such as a monolayer, a bilayer, or a trilayer. Graphene sheet 126, due to its high mechanical strength, functions as a wear protection layer for cable 128, core 102 and cladding 104. Graphene layer 126 is attached to fiber optic cable 128 such that a longitudinal axis of optic fiber core 102 is perpendicularly oriented to a plane formed by the contiguous sheet of graphene 126. It is desirable to utilize a single continguous sheet of graphene as a wear protection layer in order to maximize the mechanical strength of the graphene layer 126 to resist wear and damage. A non-contiguous sheet of graphene would not provide as much wear protection as a contiguous sheet. Further, a single contiguous sheet of graphene 126 that is of uniform thickness has uniform light transmission properties optimizing it for transmission of fiber optic signals. A non-contiguous sheet of non-uniform thickness would scatter light and degrade the strength of the fiber optic signal.

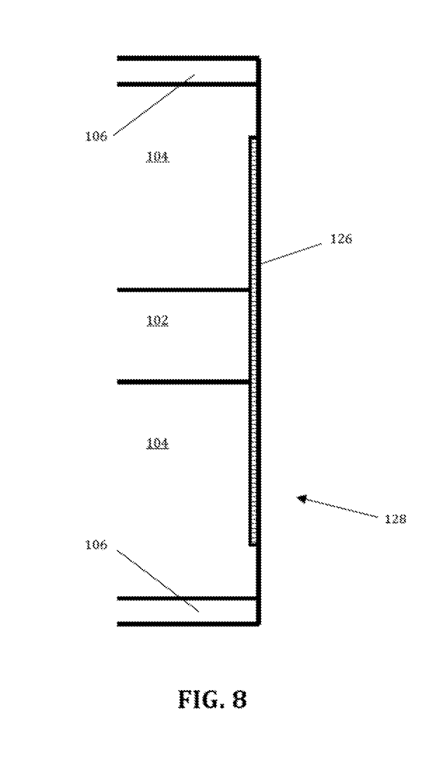

FIG. 8 illustrates a sectional view of an end of a fiber optic cable 128 having a graphene sheet 126 covering a fiber optic core 102. Fiber optic cable 128 includes a core 102, cladding 104 and insulating coating 106. Graphene layer 126 is attached to fiber optic cable 128 such that a longitudinal axis of optic fiber core 102 is perpendicularly oriented to a plane formed by the contiguous sheet of graphene 126. Graphene sheet 126 may be secured to cable core 102 and cladding 104 by a variety of methods. Graphene sheet 126 may be attached with an adhesive. Exemplary adhesives for graphene sheet 126 include, but are not limited to, cyanoacrylates, such as methyl-2-cyanoacrylate and ethyl-2-cyanoacrylate. Any adhesive capable of bonding a graphene sheet 102 to core 102 and cladding 104 is contemplated. Alternatively, the end-surface 114 of core 102 and/or cladding 104 may be flash heated with a laser. This flash heating softens the end-surface 114 of core 102 and cladding 104 sufficiently to enable graphene 126 to be embedded in the end-surface of core 102 and cladding 104. Also alternatively, a solvent may be used to soften the end-surfaces of core 102 and cladding 104 sufficient to enable graphene 126 to be embedded in the end-surface of core 102 and cladding 104. The use of flash heating is preferred for cables that have core 102 and cladding 104 made of silica. The use of solvents is preferred for cables that have core 102 and cladding 104 made of a polymer. As shown, graphene layer 126 has a uniform thickness and is contiguous. Graphene layer 126 allows the cleaning of end-surfaces 114 to remove light-blocking debris, and to protect end-surfaces 114 from scratches, pits, and other light degrading defects.

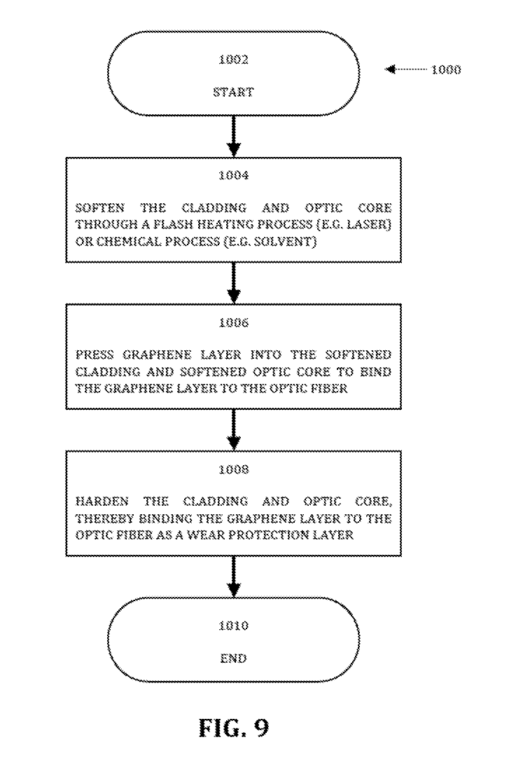

FIG. 9 illustrates a flow chart 1000 depicting a process for securing a graphene sheet to a fiber optic cable for wear protection. The process begins with START in step 1002. In step 1004, the cladding and/or core end-surface of a fiber optic cable is softened through a flash heating process with a laser or a chemical process with a solvent. In step 1006, a graphene layer is pressed into the softened cladding and/or optic core to bind the graphane layer to the optic fiber cable. In step 1008, the cladding and/or optic core are hardened, thereby binding the graphene layer to the optic fiber cable. As such, the graphene layer functions as a wear protection layer for the end of the optic fiber cable. The process ENDS in step 1010.

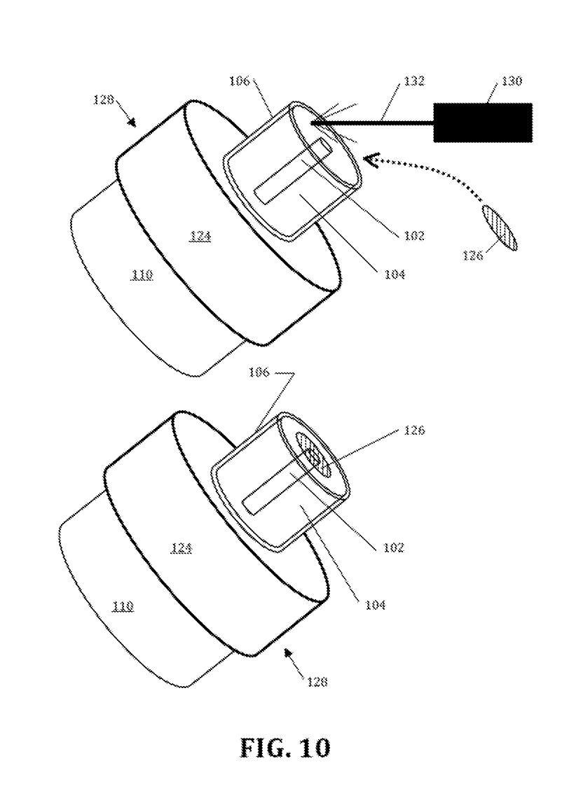

FIG. 10 illustrates a flow diagram depicting an exemplary process for securing a graphene sheet 126 to a fiber optic cable 128 for wear protection. At the top of the figure, an assemble fiber optic cable 128 with a fiber optic connector 124 is shown. The graphene sheet 126 is separate from fiber optic cable 128. A laser 130 shines a laser beam 132 onto the end-surface 114 of core 102 and cladding 104 to soften the end-surfaces by flash heating. Graphene layer 126 is then pressed into position on the end-surface of core 102 and cladding 104. The softened surfaces of core 102 and cladding 104 are then hardened, by cooling, binding graphene layer 126 to fiber optic cable 128 as shown in the bottom of the figure. In an alternate embodiment, strengthening fibers 108 are used to secure graphene layer 126.

While a conceptual connector 124 is shown, it is contemplated that any connector configuration may be used in combination with a graphene wear protection layer 126 embedded on the end of optic core 102 and cladding 104.

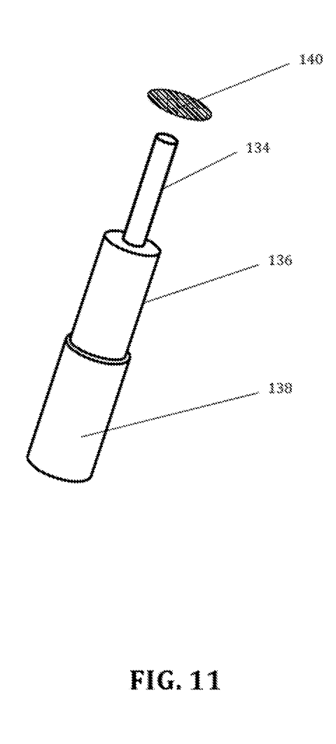

FIG. 11 illustrates an isometric view of a fiber optic cable in which an optic fiber 134 and cladding 136 are contained within a carbon nanotube 138. Optical fiber 134 is formed of an optical nanofiber that can have diameters that can range, for example, from 20 nm to 200 nm. For example, optic fiber 134 may be formed of a subwavelength-diameter optical fiber (SDF or SDOF). An SDF is an optical fiber whose diameter is less than the wavelength of the light being propagated through the fiber. An SDF fiber may have a diameter that ranges from 200 nm to 20 nm for example. Nanofibers 134 are extremely fragile. In order to provide strength to nanofiber 134, nanofiber 134 is contained within a nanotube 138 that provides mechanical strength. One type of nanotube 138 is a carbon nanotube. Nanofiber 134 is shown contained within cladding 136. Carbon nanotubes having inner diameters, for example, of 100 nm-200 nm may be used to provide support for nanofiber 134. The ranges in diameter for the nanofibers 134 and carbon nanotubes 138 are exemplary. It is contemplated that carbon nanotubes and nanofibers having diameters outside of these ranges may be used together in combination to form a fiber optic cable. Optic fiber 134 may be optionally contained within cladding 136 that is also contained within nanotube 138. Nanotube 138 may be formed of a carbon nanotube. Alternatively, nanotube 138 could be formed of an inorganic nanotube. One type of inorganic nanotube is a metal oxide. Typical inorganic nanotube materials are 2D layered solids such as tungsten(IV) sulfide (WS₂), molybdenum disulfide (MoS₂) and tin(IV) sulfide (SnS₂). WS₂ and SnS₂/tin(II) sulfide (SnS) nanotubes have been synthesized in macroscopic amounts. However, traditional ceramics like titanium dioxide (TiO₂) and zinc oxide (ZnO) also form inorganic nanotubes. More recent nanotube materials are transition metal/chalcogen/halogenides (TMCH), described by the formula TM₆C_{y}H_{z}, where TM is transition metal (molybdenum, tungsten, tantalum, niobium), C is chalcogen (sulfur, selenium, tellurium), H is halogen (iodine), and the composition is given by 8.2<(y+z)<10. TMCH tubes can have a subnanometer-diameter, lengths tunable from hundreds of nanometers to tens of microns and show excellent dispersiveness owing to extremely weak mechanical coupling between the tubes. Inorganic nanotubes are morphologically similar to a carbon nanotube. A graphene layer 140 is provided to serve as a cap to prevent damage to optic fiber 134. Graphene layer 140 may be bonded to fiber 134, and/or cladding 136, and/or nanotube 138. For example, when nanotube 138 is a carbon nanotube, cladding 140 can be bonded to nanotube 138 by placing graphene layer 140 on carbon nanotube 138 and exposing the assembly to a carbon atmosphere. Free carbon atoms will form carbon-carbon bonds between the graphene layer 140 and carbon nanotube 140, thereby bonding graphene layer 140 to nanotube 138. Alternatively, a flash heating process may be used to secure graphene layer 140 to fiber 134 and cladding 136. Also, adhesives can be used to secure graphene layer 140 to optic fiber 134, cladding 136, and/or nanotube 138.

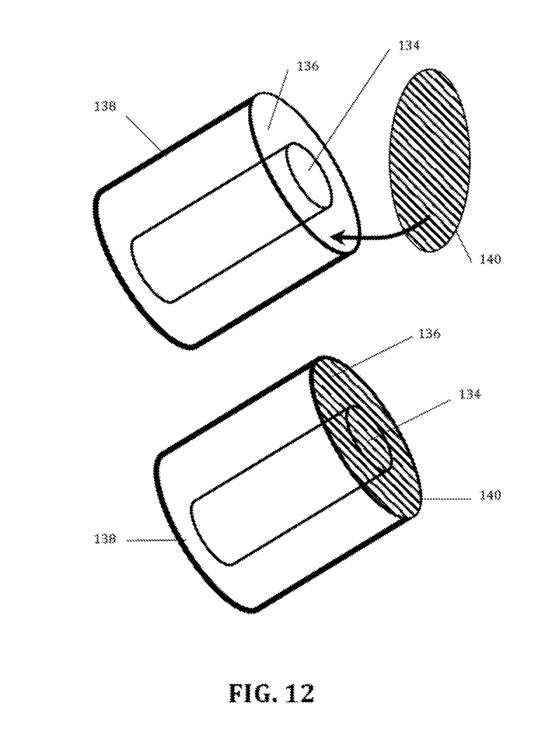

FIG. 12 illustrates an isometric view of an optic fiber 134 surrounded by cladding 136 and contained within a carbon nanotube 138 having an end covered with a graphene layer 140. At the top of FIG. 12, optic fiber 134 is contained within cladding 136 that is contained within a nanotube 138. Graphene layer 140 is shown separated in the top portion of the figure for illustrative purposes. In the bottom portion of FIG. 12, graphene layer 140 is shown secured to fiber 134, cladding 136, and/or nanotube 138. Graphene layer 140 and carbon nanotube 138 function in combination to provide mechanical support and protection to optic fiber 134. As graphene layer 140 is optically transparent, its placement does not inhibit the function of optic fiber 134.

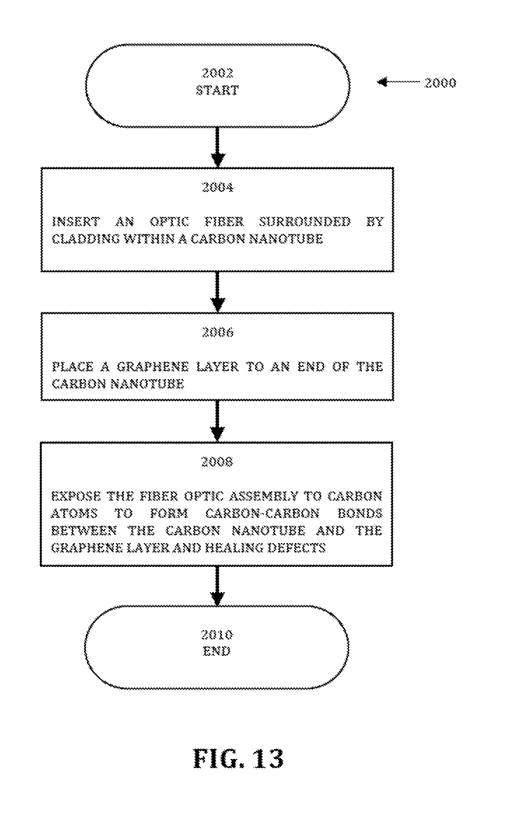

FIG. 13 illustrates a flow chart 2000 depicting an exemplary process for securing a graphene sheet 140 to a fiber optic cable that is formed of an optic fiber 134 surrounded by cladding 136 contained within a carbon nanotube 138. The process begins with START 2002. In step 2004, an optic fiber 134 surrounded by cladding 136 is inserted within a carbon nanotube. Alternatively, it is contemplated that other methods of placing an optic fiber within a carbon nanotube might be used, such as growing the nanotube around the optic fiber. In step 2006, a graphene layer 140 is placed on the end of the carbon nanotube 138. In step 2008, the assembly formed of the optic fiber 134, cladding 136, carbon nanotube 138 and graphene sheet 140 is exposed to free carbon atoms to form carbon-carbon bonds between the carbon nanotube 138 and the graphene layer 140 to bond the graphene layer 140 to the carbon nanotube 138. The process ENDS in step 2010. When graphene layer 140 is bonded to carbon nanotube 138, a contiguous end cap is formed protecting optic fiber 134.

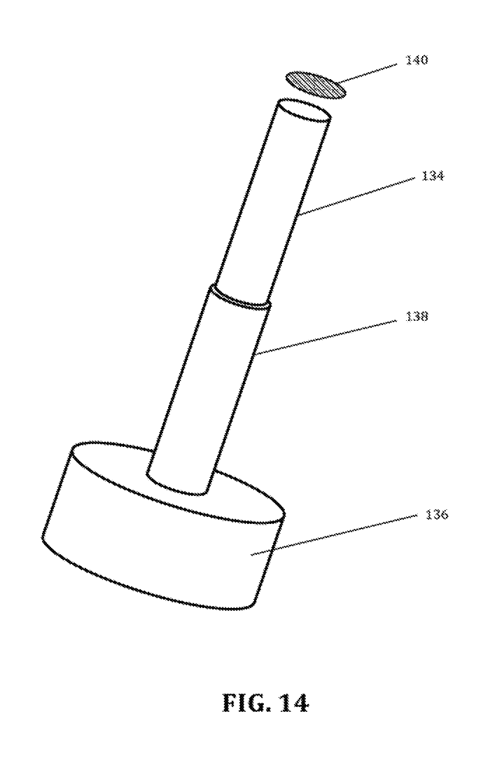

FIG. 14 illustrates an isometric view of an alternative fiber optic cable in which an optic fiber 134 is contained within a nanotube 138 where the cladding 136 is surrounding the nanotube 138. In this embodiment, cladding 136 is on the exterior of nanotube 138. There is no cladding 136 within nanotube 138. Nanotube 138 contained optic fiber 134 only. Graphene layer 140 is provided to cover the end of nanotube 138 in order to protect optic fiber 134. Note that the use of cladding 136 is optional. The fiber optic cable can be formed of a nanotube 138 and optic fiber 134 without the use of cladding 136. For example, interconnect for optical computers or optical processors could be formed of nanotubes 138 containing optic fibers 134.

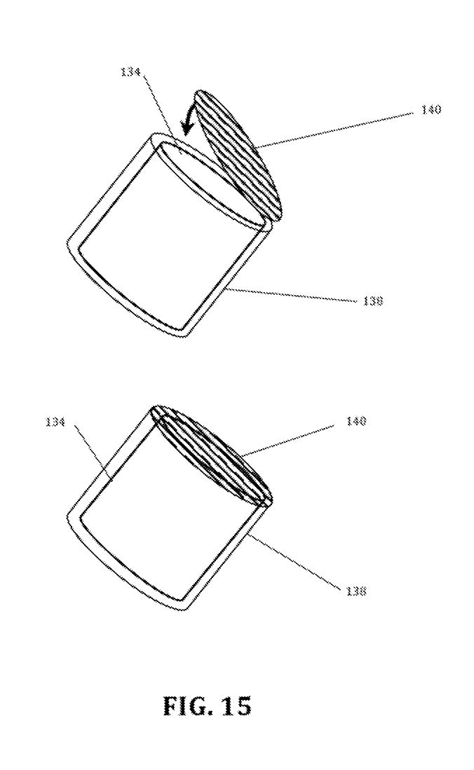

FIG. 15 illustrates an isometric view of an optic fiber 134 contained within a nanotube 138 having an end covered with a graphene layer 140. Nanotube 138 has a longitudinal axis that is aligned with a longitudinal axis of optic fiber 134. In FIG. 15, as optic fiber 134 is contained within nanotube 138, optic fiber 134 and nanotube 138 share the same longitudinal axis. Optic fiber 134 is longitudinally aligned with nanotube 138 within nanotube 138. Nanotube 138 provides mechanical support to optic fiber 134. Graphene layer 140 provides protection to optic fiber 134. Graphene layer 134 is bonded to nanotube 138. For example, exposure to free carbon atoms can form carbon-carbon bonds between graphene layer 134 and a carbon nanotube 138. Further, if there are any defects in carbon nanotube 138 or graphene layer 140, exposure to free carbon atoms, preferably in an oxygen-free atmosphere, can heal those defects through the free carbon atoms bonding to the defect sites in the carbon nanotube 138 or graphene layer 140. When graphene layer 140 is bonded to carbon nanotube 138, a contiguous end cap is formed protecting optic fiber 134.

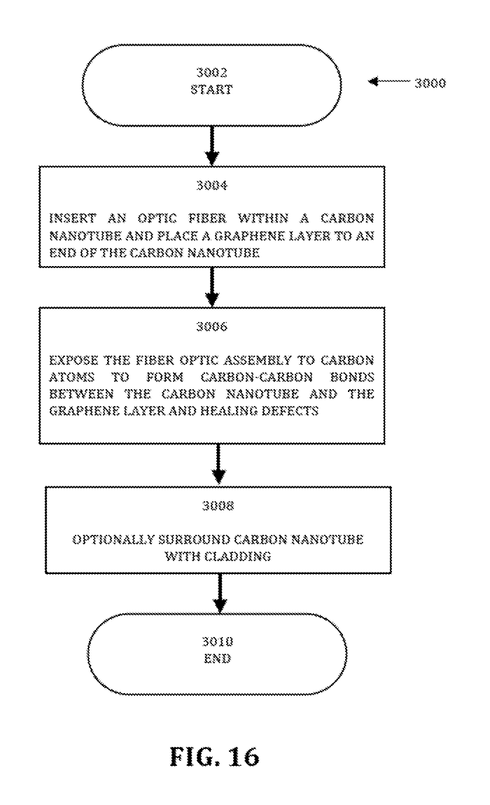

FIG. 16 illustrates a flow chart 3000 depicting an exemplary process for securing a graphene sheet 140 to a fiber optic cable that is formed of an optic fiber 134 contained within a carbon nanotube 138. The process begins with START 3002. In step 3004, an optic fiber 134 is inserted within a carbon nanotube 138 and a graphene layer 140 is placed on the end of carbon nanotube 138. In step 3006, the fiber optic assembly formed of the optic fiber 134, carbon nanotube 138 and graphene layer 140 is exposed to free carbon atoms, preferably in an oxygen-free atmosphere, so that carbon-carbon bonds will form between carbon nanotube 138 and graphene layer 140. In step 3008, carbon nanotube 138 may be optionally surrounded with cladding 136. The process ENDS in step 3010.

While the invention has been shown and described with reference to a particular embodiment thereof, it will be understood to those skilled in the art, that various changes in form and details may be made therein without departing from the spirit and scope of the invention.

1. A fiber optic cable, comprising an optic fiber contained within a nanotube.

2. The fiber optic cable of claim 1, wherein said nanotube is a carbon nanotube.

3. The fiber optic cable of claim 1, wherein said nanotube is an inorganic nanotube.

4. The fiber optic cable of claim 3, wherein said inorganic nanotube is formed of a metal oxide.

5. The fiber optic cable of claim 3, wherein said inorganic nanotube is formed of a transition metal-chalcogen-halogenide material.

6. The fiber optic cable of claim 1, further comprising cladding, wherein said cladding surrounds said optic fiber, wherein said cladding is contained within said nanotube.

7. The fiber optic cable of claim 1, further comprising cladding, wherein said cladding surrounds said nanotube.

8. The fiber optic cable of claim 1, wherein said optic fiber is a nanofiber.

9. The fiber optic cable of claim 1, further comprising a graphene layer covering an end-surface of said optic fiber.

10. The fiber optic cable of claim 9, wherein said graphene layer is attached to the end-surface of said optic fiber.

11. The fiber optic cable of claim 9, wherein said graphene layer is formed of a contiguous sheet of graphene.

12. The fiber optic cable of claim 11, wherein said contiguous sheet of graphene has a uniform thickness.

13. The fiber optic cable of claim 12, wherein said contiguous sheet of graphene is a monolayer of carbon atoms.

14. The fiber optic cable of claim 12, wherein a longitudinal axis of said optic fiber being perpendicularly oriented to a plane formed by said contiguous sheet of graphene.

15. The fiber optic cable of claim 9, wherein said graphene layer is attached to said nanotube.

16. The fiber optic cable of claim 15, wherein said nanotube is a carbon nanotube, wherein said graphene layer is attached to said carbon nanotube by carbon-carbon bonds formed between said graphene layer and said carbon nanotube.

17. A fiber optic cable, comprising:
an optic fiber contained within a carbon nanotube; and
a graphene layer covering an end-surface of said optic fiber, wherein said graphene layer is attached to said carbon nanotube by carbon-carbon bonds formed between said graphene layer and said carbon nanotube

18. The fiber optic cable of claim 17, wherein said carbon nanotube has a longitudinal axis that is aligned with a longitudinal axis of said optic fiber.

19. The fiber optic cable of claim 17, wherein said optic fiber and said carbon nanotube share a longitudinal axis.

20. The fiber optic cable of claim 17, wherein said optic fiber is longitudinally aligned with said carbon nanotube within said carbon nanotube.
